(19) United States
(12) Patent Application Publication
(10) Pub. No.: US 2015/0107556 A1
(43) Pub. Date: Apr. 23, 2015

(54) METHOD AND SYSTEM FOR CONTROL OF AT LEAST A SPEED REGULATOR

(71) Applicant: SCANIA CV AB, Södertälje (SE)

(72) Inventors: Oskar Johansson, Stockholm (SE); Mikael Ögren, Norsborg (SE); Martin Evaldsson, Nacka (SE)

(73) Assignee: SCANIA CV AB, Södertälje (SE)

(21) Appl. No.: 14/390,116

(22) PCT Filed: Mar. 28, 2013
(86) PCT No.: PCT/SE2013/050350

§ 371 Date: Oct. 2, 2014

(30) Foreign Application Priority Data
Apr. 5, 2012 (SE) 1250349-6

(51) Int. Cl. F02D 31/00; B60K 31/00; F02D 29/02

(52) U.S. Cl. CPC F02D 31/001; F02D 29/02; B60K 31/00
USPC 123/350

(57) ABSTRACT

A method and a system for control of at least one speed regulator (120), which regulator (120) regulates an engine system (130) in a vehicle (100) on the basis of a regulating algorithm so that an actual speed v_{act} of said vehicle (100) is guided towards a target speed v_{des}. A change in the target speed v_{des} is identified. This is followed by determination of an absolute value of a memory term in the regulating algorithm and determination of a configuration of said absolute amount. If the configuration of the absolute value is not desirable, the influence of the regulating algorithm upon the engine system (130) is curtailed.

### TECHNICAL FIELD

The present invention relates to a method for control of at least one speed regulator according to the preamble of claim 1 and a system for control of at least one speed regulator according to the preamble of claim 24.

The present invention relates also to a computer programme and a computer programme product which implement the method according to the invention.

### BACKGROUND

In motor vehicles, e.g. cars, trucks and buses, an engine system is usually controlled by means of a regulator, a so-called speed regulator, which may be situated in an engine control unit of the vehicle but may also be situated elsewhere on board. The speed regulator regulates a torque which is demanded from the engine system and which usually varies over time, e.g. when the speed of a vehicle has to be altered or the vehicle comes to an upgrade or a downgrade.

FIG. 1a depicts schematically an example of a heavy vehicle 100, e.g. a truck, bus or the like. The vehicle depicted comprises a forward pair of wheels 111, 112 and a rear pair of tractive wheels 113, 114. It further comprises a power train with an engine system 130 which in a conventional way, via an output shaft 102 from the engine system is connected to a gearbox 103, e.g. via a clutch 106.

An output shaft 107 from the gearbox 103 drives the tractive wheels 113, 114 via a final gear 118, e.g. a conventional differential, and driveshafts 104, 105 which are connected to said final gear. The engine system 130 may be equipped with a turbo unit 131.

Cruise control is now usual in motor vehicles such as cars, trucks and buses. One purpose of cruise control is to achieve a uniform predetermined vehicle speed either by adjusting the engine torque to avoid deceleration or by applying brake action on downhill runs where the vehicle is accelerated by its own weight. A more general purpose of cruise control is to provide the vehicle's driver with easy driving and more comfort.

FIG. 1a and FIG. 1b illustrate schematically part of a cruise control system and its function, whereby a driver of a motor vehicle with a cruise control 110 usually chooses a set speed vₛₑₜ which he/she wishes the vehicle to maintain on level roads. The cruise control 110 then conveys to a speed regulator 120 a reference speed v_{ref}, i.e. a target speed v_{des}, which may be regarded as a set-point value for the vehicle's speed. The reference speed v_{ref} is used by the speed regulator to determine a torque M which it demands from an engine system 130 of the vehicle. The result of this torque demanded M is the actual speed v_{act} which the vehicle consequently assumes.

The set speed vₛₑₜ may therefore be regarded as an input signal to the cruise control, and the reference speed v_{ref} as an output signal from the cruise control which is used as a target speed v_{des} for control of the engine by means of the speed regulator. In other words, the reference speed v_{ref} here serves as the set-point value for the vehicle's speed and is herein also referred to as the target speed v_{des}.

One skilled in the art will appreciate that the cruise control 110 may also be replaced by a command from the driver. Thus the target speed v_{des} may also be conveyed to the speed regulator 120 as a result of the driver operating the vehicle's controls, e.g. an acceleration control such as an accelerator pedal or the like.

In today's traditional cruise controls (CCs) the reference speed v_{ref} is identical with the set speed vₛₑₜ chosen by the user of the system, e.g. a driver of the vehicle. These CCs therefore maintain a constant reference speed v_{ref} corresponding to the set speed vₛₑₜ chosen by the driver. The value of the reference speed v_{ref} here changes only when adjusted by the user during the journey.

There are today cruise controls known as economical cruise controls, e.g. Ecocruise and the like, which try to estimate current running resistance, also have knowledge about the historical running resistance and allow the reference speed v_{ref} to differ from the set speed vₛₑₜ chosen by the driver. A cruise control which allows such difference is herein referred to as a reference-speed-regulating cruise control.

There are various types of regulators. We describe here the function and the algorithm of a PID regulator, but one skilled in the art will appreciate that other types/variants of regulators work in similar ways. The present invention may be implemented for all such other types/variants of regulators.

A PID regulator is a regulator which gives an input signal u(t) to a system, e.g. the engine system 130, on the basis of a difference e(t) between a desired output signal r(t), which in this specification corresponds to the target speed v_{des}, and an actual output signal y(t) which in this specification corresponds to the actual speed v_{act}. In the case referred to below, e(t)=r(t)−y(t) according to

$$u ( t ) = {K}_{p} e ( t ) + {K}_{I} {\int }_{0}^{t} e ( τ ) d τ + {K}_{D} \frac{d e ( t )}{d t} \qquad ( eq . 1 )$$

in which
Kₚ is an amplification constant,
K_{I} an integration constant, and
K_{D} a derivation constant.

A PID regulator regulates in three ways, viz. by a proportional amplification (P; Kₚ), by an integration (I; Kᵢ) and by a derivation (D; K_{d}).

The constants Kₚ, Kᵢ and K_{d} affect the system as follows.

An increased value for the amplification constant Kₚ leads to the following changes in the PID regulator:
increased rapidity,
reduced stability margins,
improved compensation of process disturbances, and
increased control signal activity.

An increased value for the integration constant Kᵢ leads to the following changes in the PID regulator:
better compensation of low-frequency process disturbances (eliminating residual errors pertaining to step disturbances)
increased rapidity, and
reduced stability margins.

An increased value for the derivation constant K_{d} leads to the following changes in the PID regulator:
increased rapidity,
increased stability margins, and
increased control signal activity.

The regulating algorithm for a PID regulator is well-known to one skilled in the art, who will also be familiar, as mentioned above, with other types/variants of regulators/regulating algorithms and their similarities to/differences from the PID regulator.

### BRIEF DESCRIPTION OF THE INVENTION

If the speed regulator 120 has for a lengthy period had in its algorithm a relatively large regulating error e, it is, depending on the function of the speed regulator's regulating algorithm, not possible to make the rapid changes in the torque M which are required to be able to follow an optimum curve for the vehicle's actual speed v_{act} and thereby be able to optimise the vehicle's speed profile, with consequent potential for also optimising its fuel consumption.

In other words, an inertia of the torque M is built up over the time which the algorithm in the speed regulator 120 takes to perform its calculations, owing to regulating error e incorporated in the algorithm. There is therefore risk of torque uprampings and downrampings being slow, e.g. at large steps in the set-value v_{des}. This slowness may cause problems as regards optimum control of speed adjustment and fuel consumption.

The regulating error e in the speed regulator is due to the difference between the speed set-point value, i.e. the target speed v_{des}, and the current value of the vehicle's speed, i.e. the actual speed v_{act}. Particularly when there are relatively large changes in the vehicle's actual speed v_{act}, e.g. when travelling uphill or downhill, this regulating error e will be relatively large for relatively long periods of time, with consequent build-up of inertia of the torque M.

Reference-speed-regulating cruise controls, e.g. “look-ahead” cruise controls (LACC), use knowledge about road sections ahead to determine the configuration of the reference speed v_{ref}. The reference speed v_{ref} is therefore here allowed, within a speed range, to differ from the set speed vₛₑₜ chosen by the driver, in order to achieve more economical operation from a fuel perspective. LACCs typically adjust the reference speed v_{ref} to achieve a desired profile for the vehicle's actual speed v_{act} over a predetermined distance traveled. As the reference speed v_{ref} here serves as the target speed v_{des} in the regulating algorithm, these adjustments of the reference speed v_{ref} often cause the regulating error e in the regulating algorithm, thereby building up the inertia of the torque M.

An object of the present invention is to make rapid changes possible for the torque M.

This object is achieved by the aforesaid method for control of at least one speed regulator, according to the characterising part of claim 1. It is also achieved by the aforesaid system for control of at least one speed regulator, according to the characterising part of claim 23.

The present invention makes rapid changes in the torque M possible by enabling the system to choose whether a previous build-up is to be maintained or not for the torque M. According to the present invention this may be achieved by influencing the inertia which arises from an incremented memory term/memory element of the regulating algorithm.

The memory element of the regulating algorithm is related to the history of the speed regulator, since the memory element typically depends on an integration of the regulating error e in the algorithm. If for example a relatively large regulating error e is integrated upwards, e.g. before a change in the target speed v_{des} takes place, the vehicle's actual speed v_{act} would in previous known systems react slowly when the change in the target speed v_{des} takes place. With the present invention, the vehicle's actual speed v_{act} reacts considerably more quickly to the change in the target speed v_{des}, since the influence of the regulating algorithm upon the engine system is curtailed if the memory term has an undesirable configuration, as it does in one embodiment if its absolute amount decreases after a change, e.g. a step, in the target speed v_{des} has been identified.

In one embodiment of the present invention, the curtailment of the regulating algorithm's influence takes the form of a temporary departure from regulation based on the algorithm. Here an engine torque demanded may for example be limited at the change in the target speed v_{des}. After this limitation of torque demanded has initially been utilised after the change in the target speed v_{des}, the system reverts to regulation based on the algorithm.

In one embodiment of the present invention, the curtailment of the regulating algorithm's influence takes the form of manipulation of the memory term in the algorithm, e.g. by the memory term being set to a suitable value initially at the change in the target speed v_{des}.

In one embodiment, this suitable value to which the memory term is set is zero (0), corresponding to elimination of the memory term in the regulating algorithm. The algorithm thus no longer remembers what previously happened during the regulation of the engine system, and the engine system's torque inertia has therefore been considerably reduced, which means that a desired speed curve can be followed more exactly, resulting in cruise control and speed regulation which are more efficient from a fuel economy perspective.

The present invention thus results in cruise control which is more fuel-efficient, which a driver will also intuitively regard as positive, since irritating delays in the system are minimised and a more instantaneous speed regulation is achieved.

In one embodiment of the present invention, losses in the power train may also be controlled when a change, e.g. a step, in the target speed v_{des} has been identified. Here it is for example possible to choose to influence parasitic losses, e.g. in a generator, a cooling fan or an air processing system which consume energy in the power train. A further example of measures to reduce the losses in the power train comprise lowering the exhaust backpressure considerably and/or operating the gearbox in such a way that less energy is consumed by engaging a higher gear or freewheeling. Another aspect is that an increased running resistance will enable the vehicle to reach a lower speed more quickly if this is desirable.

### BRIEF LIST OF DRAWINGS

The invention is explained in more detail below with reference to the attached drawings, in which the same reference notations are used for similar items, and

FIG. 1a is a schematic drawing of a vehicle,

FIG. 1b is a schematic diagram of a cruise control, a speed regulator and an engine system,

FIG. 2 is a flowchart for the method according to the present invention,

FIG. 3 is a schematic illustration of the function of the present invention,

FIG. 4 illustrates schematically the build-up of the P, I and D elements in the regulating algorithm,

FIG. 5 depicts a control unit according to the present invention.

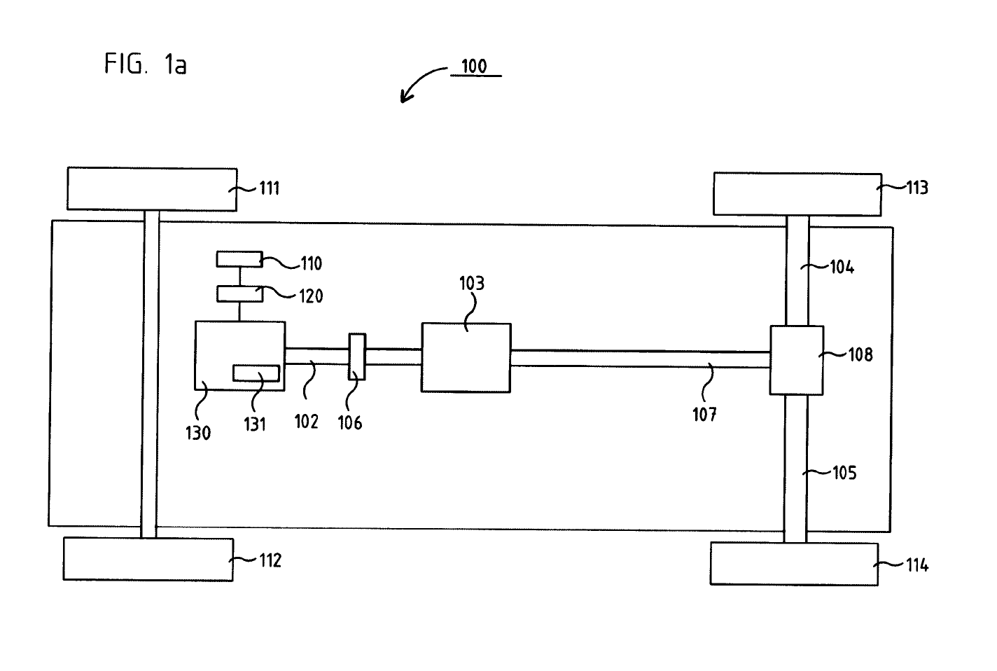

### DESCRIPTION OF PREFERRED EMBODIMENTS

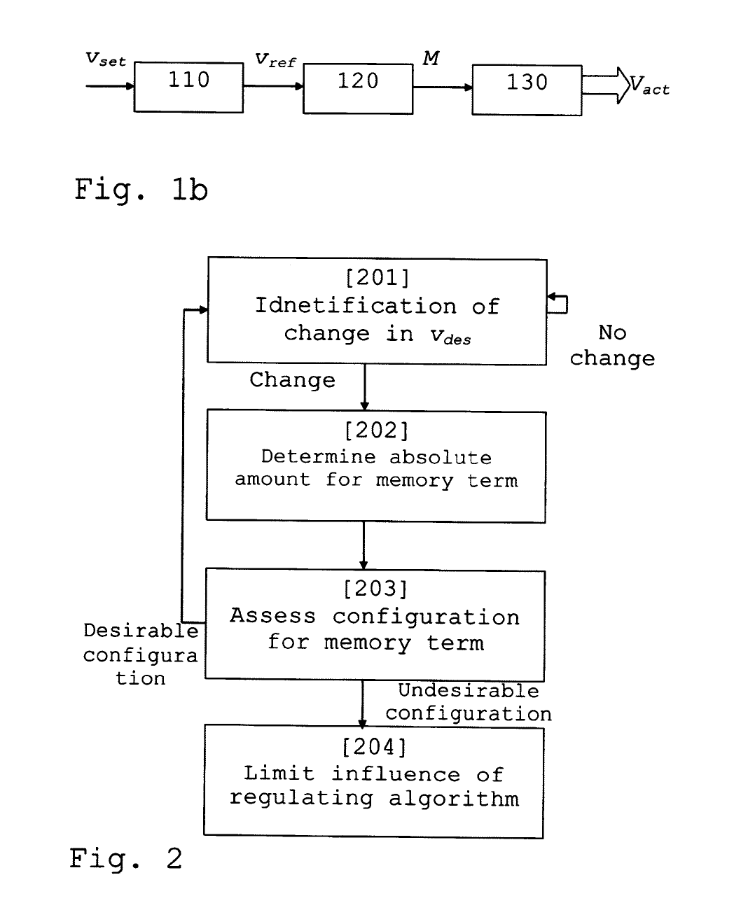

FIG. 2 is a schematic flowchart for the method according to an aspect of the present invention.

The method begins with a first step [201] in which a change in the target speed v_{des} is identified. As a second step [202] of the method, which is performed if a change in the target speed v_{des} is identified at the first step [201], an absolute amount is determined for a memory term of the regulating algorithm used by the regulating system. This memory term is related to a history of how the speed regulator previously regulated the engine system. If PID regulation is used, the magnitude of the I term ∫₀^{t}e(τ)dτ d is determined by determining its absolute amount |∫₀^{t}e(τ)dτ|.

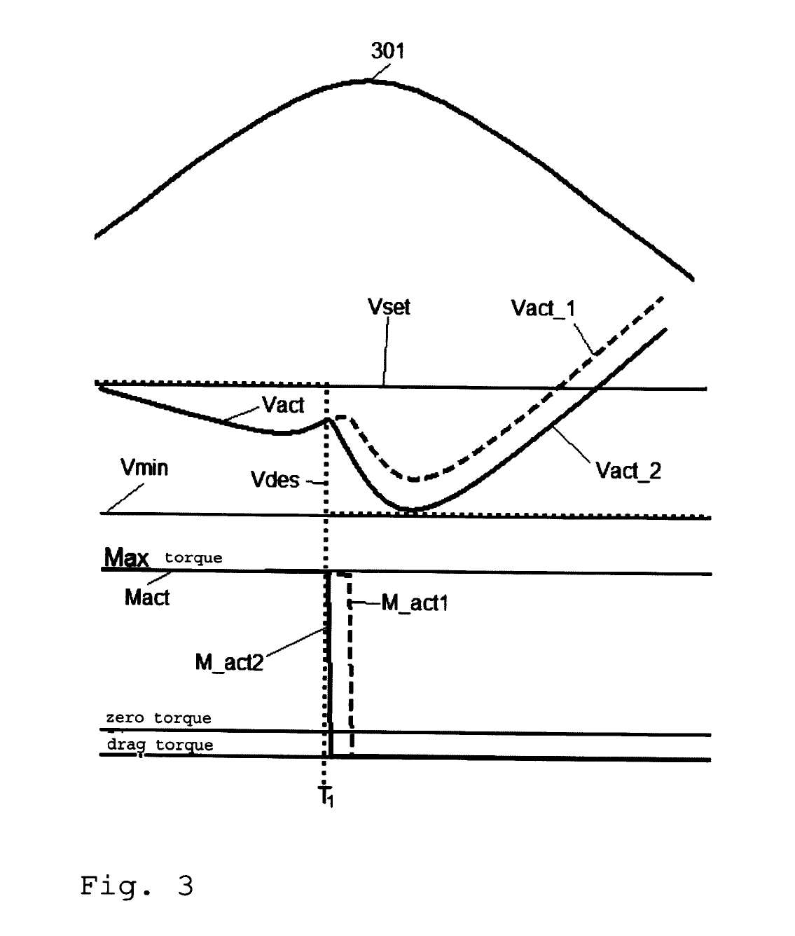

The third step [203] of the invention assesses whether the I term's absolute amount |∫₀^{t}e(τ)dτ| has a desirable configuration or not. An example of an undesirable configuration is if the absolute amount decreases after the change in the target speed v_{des}. This may for example happen when an engine torque M demanded of the engine system 130 changes from a substantially maximum engine torque to a drag torque, as illustrated in FIG. 3, which is described in more detail below. When the engine system is dragged, it contributes substantially no propulsive force, e.g. when the fuel supply to the engine system is throttled.

In the fourth step [204] of the method, which is performed if at the third step [203] it is determined that the I term's absolute amount |∫₀^{t}e(τ)dτ| has an undesirable configuration, the present invention results in a curtailment of the regulating algorithm's influence upon the engine system.

According to the present invention, curtailment of the regulating algorithm's influence therefore allows the regulating system to choose whether a previous build-up is to be maintained or not for the torque M, enabling rapid changes in the torque M.

In one embodiment of the present invention, the curtailment of the regulating algorithm's influence takes the form of manipulation of the memory term in the regulating algorithm.

The memory term may here be determined to have any suitable value which enables rapid changes for the torque M. The memory term may here be set to this suitable value initially when the change in the target speed v_{des} has been detected.

In one embodiment this suitable value is one which causes the memory term in the regulating algorithm to take out, i.e. compensate for, a proportional term and a derivative term in the algorithm. If for example a PID regulating algorithm is used, the I term is therefore given a value such that it initially takes out the P term and the D term.

In one embodiment, this suitable value is zero (0), corresponding to elimination of the memory term in the regulating algorithm for the speed regulator 120. The memory term is related to a history of the speed regulator's regulation of the engine system 130, so the algorithm after the elimination no longer remembers what previously happened during the regulation of the engine system. The torque inertia of the engine system may thus be considerably reduced. As described above, the elimination takes place here if a change in the target speed v_{des} has been detected and it is determined that the memory term's configuration is undesirable.

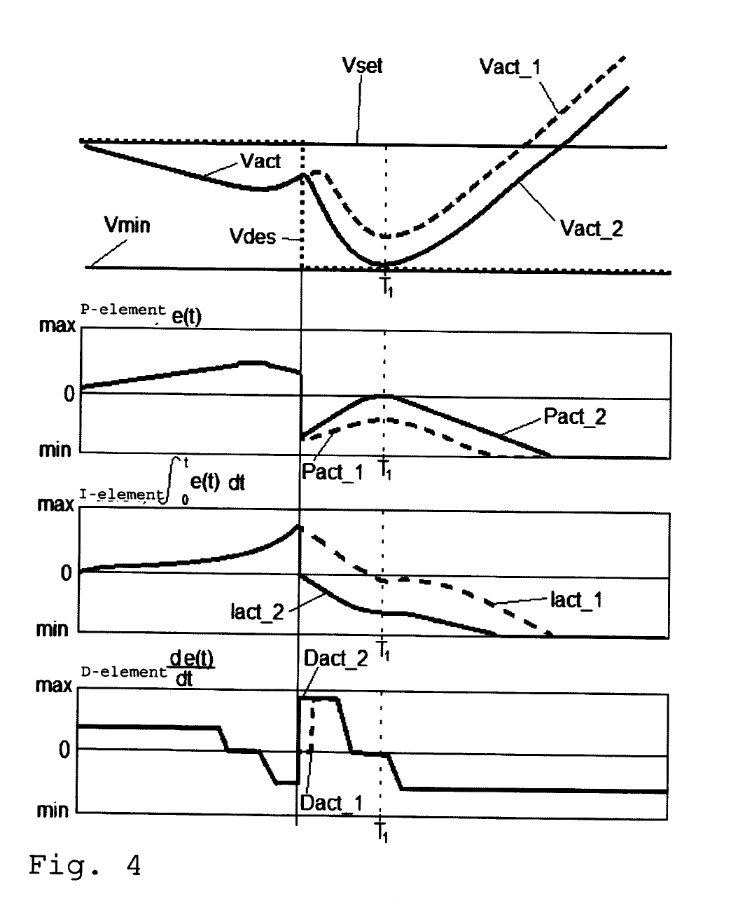

In one embodiment the memory term's configuration is undesirable if its absolute amount decreases after a change, e.g. a step, in the target speed v_{des} has been identified. The memory element of the regulating algorithm depends typically on integration of the regulating error e in the algorithm and therefore on the speed regulator's history. This is exemplified for a PID regulator in FIG. 4, which is described in more detail below. In FIG. 4 a regulating error e occurs because of a steep upgrade. This causes the I element to be incremented. When the target speed v_{des} takes a step downwards, I_{act}_{_{—}}₁, which corresponds to the I element in previous known systems after the step, would thereafter have begun to decrease. In this embodiment the I element built up historically at the step in the target speed v_{des} would then be eliminated, resulting in I_{act}_{_{—}}₂, which corresponds to the I element for the present invention after the step for the target speed v_{des}.

This elimination of the memory term in the regulating algorithm enables a rapid change in the torque M. This rapid change is here possible because the inertia of the torque M built up through the influence of the regulating error e during the algorithm's control of the engine system 130 consequently disappears.

The present invention thus enables quicker upramping or downramping of the torque M, since the speed regulator 120 no longer remembers the regulating error e which previously affected the algorithm.

FIG. 3 depicts schematically a non-limitative example illustrating the result of using an embodiment of the present invention. Here we have a vehicle travelling on a road section with topography according to curve 301, viz. an upgrade followed by a downgrade. If the vehicle is here equipped with a reference-speed-regulating cruise control which caters for topography, e.g. an LACC, it will allow the reference speed v_{ref}, which here takes the form of the speed regulator's target speed v_{des}, to be lowered relative to the chosen set speed vₛₑₜ just before the crest of the hill, since the cruise control expects the vehicle to be accelerated by its own weight on the downhill side. The target speed v_{des} is therefore lowered just before the crest to a lowest permissible speed vₘᵢₙ, resulting in a regulating error e because the actual speed v_{act} will deviate from the target speed v_{des} when the latter changes, as described in more detail below.

Curve v_{act}_{_{—}}₁ shows the pattern of the vehicle's actual speed v_{act}_{_{—}}₁ which arises from the lowering of the target speed v_{des} if the present invention is not applied, i.e. what the actual speed v_{act} would have been if a traditional speed regulator was used. Reference-speed-regulating cruise controls often control relatively large lowerings of the reference speed v_{ref} by setting it to a value which is well below the set speed vₛₑₜ and also well below the vehicle's actual speed v_{act}_{_{—}}₁, in other words v_{ref}<<vₛₑₜ and v_{ref}<<v_{act}_{_{—}}₁, thereby generating relatively long-lasting and large regulating error e. When the reference speed v_{ref} is set to such a low value, the lowering is effected by throttling the fuel supply, so-called “fuel cut-off”.

Curve v_{act}_{_{—}}₂ shows the pattern of the vehicle's actual speed v_{act}_{_{—}}₂ which arises from the lowering of the target speed v_{des} if an embodiment of the present invention is applied. The embodiment of the present invention here identifies that a change in the target speed v_{des}, in the form of a lowering of it, takes place.

An absolute value and a configuration for the memory term in the regulating algorithm are determined and assessed. A reference-speed-regulating cruise control for example decides whether to lower the reference speed v_{des} so that a simulated vehicle speed vₛᵢₘ along curve 301 will not fall below the lowest permissible speed vₘᵢₙ. In this embodiment of the present invention, the memory term in the algorithm has to be eliminated if a change in the target speed v_{des} takes place which results in an undesirable configuration of the memory term's absolute amount. This makes it easier for the simulated vehicle speed vₛᵢₘ and the actual vehicle speed v_{act} to be followed up. As a non-limitative example it may be mentioned that the regulating error e in the example illustrated in FIG. 3 is already relatively large from the outset and also grows to a considerable magnitude over time. Thus the curve v_{act}_{_{—}}₂ represents the vehicle's actual speed v_{act}_{_{—}}₂ if the memory term in the algorithm is eliminated according to the invention.

FIG. 3 clearly shows that the actual torque M_{act}_{_{—}}₂ according to the present invention reacts considerably more quickly to the lowering of the target speed v_{des} than the actual torque M_{act}_{_{—}}₁ according to previous known speed regulators. The present invention ramps the actual torque M_{act}_{_{—}}₂ down to drag torque substantially immediately after the lowering of the target speed v_{des}, whereas in previous known solutions the actual torque M_{act}_{_{—}}₁ takes a considerably longer time to drop to drag torque.

FIG. 3 also shows clearly that the actual speed v_{act}_{_{—}}₂ according to the present invention reacts considerably more quickly to the lowering of the target speed v_{des} to a lowest permissible speed vₘᵢₙ than the actual speed v_{act}_{_{—}}₁ according to previous known speed regulators. As schematically depicted in FIG. 3, the actual speed v_{act}_{_{—}}₂ according to the present invention turns down substantially immediately when the target speed v_{des} is lowered, whereas the actual speed v_{act}_{_{—}}₁ according to previous known regulators continues initially to increase in magnitude before turning down. This increase in the actual speed v_{act}_{_{—}}₁ is due to the inertia in torque M which built up and was stored in previous known speed regulators.

As the present invention eliminates the memory term in the regulating algorithm, and hence also the inertia in the torque M, the result is a much more flexible actual speed v_{act}_{_{—}}₂. This makes it possible for the actual speed v_{act}_{_{—}}₂ to be controlled more exactly, which also results in less fuel consumption and a more distinct and instantaneous operating sensation for the driver.

In one embodiment of the present invention, the curtailment of the regulating algorithm's influence takes the form of temporary departure from regulation based on the algorithm.

Here an engine torque demanded may for example be limited at the change in the target speed v_{des}. After this limitation of engine torque demanded has initially been utilised after the change in the target speed v_{des}, the system reverts to regulation based on the algorithm. To achieve a smooth transition when the system reverts to regulation according to the regulating system, it is possible in one embodiment of the invention for the memory term in the algorithm to be initiated, i.e. to be given a value, so that it assumes a value which results in a gentle transition to regulation according to the algorithm.

In the example depicted in FIG. 3, the engine torque might be limited to below or equal to zero, M≦0, substantially immediately after the change in the target speed v_{des}, resulting in an immediate response to the change. In one embodiment the temporary departure is only applied initially after the change in the target speed v_{des}. The temporary departure may for example cease if the speed regulator 120 itself demands an engine torque which is below or equal to zero, M≦0, or if the actual speed v_{act} differs from the target speed v_{des} by a differential speed v_{diff} or less, i.e. v_{act}−v_{des}≦v_{diff}, where the differential speed v_{diff} may for example have a value of 0.5 km/h, i.e. v_{diff}=0.5 km/h.

In one embodiment of the present invention, the speed regulator according to the invention uses a PID algorithm, i.e. the speed regulator is a PID regulator.

As described above, there is often a regulating error e in the algorithm which is integrated upwards in the PID regulator. This is illustrated schematically in FIG. 4 for topography corresponding to the topographic curve 301 in FIG. 3. FIG. 4 illustrates schematically how the P, I and D elements in the PID algorithm vary in magnitude, both when the present invention is not employed (broken lines with index _{—}1) and when it is employed (continuous lines with index _{—}2), as described in more detail below. One skilled in the art will appreciate that similar diagrams are possible with other types/variants of regulating algorithms.

The P term in the PID algorithm takes the form in this embodiment of the term for proportional amplification, which in previous known solutions, P_{act}_{_{—}}₁, has a shape corresponding to the target speed v_{des} minus the actual vehicle speed v_{act}_{_{—}}₁ and multiplied by a constant Kₚ, i.e. P_{act}_{_{—}}₁=(v_{des}−v_{act}_{_{—}}₁)*Kₚ, and for the present invention, P_{act}_{_{—}}₂, it has a shape corresponding to the target speed v_{des} minus the actual vehicle speed v_{act}_{_{—}}₂ multiplied by a constant Kₚ, i.e. P_{act}_{_{—}}₂=(v_{des}−v_{act}_{_{—}}₂)*Kₚ.

As may be seen in FIG. 4, the term for proportional amplification according to the present invention, P_{act}_{_{—}}₂, after the lowering of the target speed v_{des} reaches almost zero at the first time T₁. The term for proportional amplification in previous known solutions, P_{act}_{_{—}}₁, reaches at the first time T₁ a value which is relatively far from zero. This is because the I term in previous known solutions, I_{act}_{_{—}}₁, is integrated before the lowering and thereafter affects the system for a period of time after the target speed v_{des} has changed value, and because the vehicle is thereafter accelerated downhill by its train weight.

The I term in the PID algorithm takes the form in this embodiment of the memory term, which is integrated upwards to a larger and larger value when there is a regulating error e. In previous known solutions, I_{act}_{_{—}}₁, the I element has a continuous curve, but in the embodiment of the present invention in which the I term is eliminated the curve I_{act}_{_{—}}₂ is discontinuous because of a jump which occurs at the elimination of the I term. As may be seen in FIG. 4, this embodiment eliminates the memory term if a change in the target speed v_{des} has been identified and the absolute amount of the I element has an undesirable configuration. This may for example occur if the vehicle's engine system will be dragged or if a reference-speed-regulating cruise control changes the reference speed.

The elimination of the I term may in practice take place in such a way that the integrating term is set to the value zero, as depicted in FIG. 4. This elimination then results in the PID speed regulator adopting a PD action of the regulator in close proximity to the change in the target speed v_{des}.

After the elimination, the I term for this embodiment, I_{act}_{_{—}}₂, has in the example in FIG. 4 a value which is initially zero (0) and is lower than corresponding terms in previous known solutions, I_{act}_{_{—}}₁. This allows rapid changes in the torque M, as described above.

The D term in the PID algorithm takes the form in this embodiment of the term for derivation, which in previous known solutions, D_{act}_{_{—}}₁, and for the embodiment, D_{act}_{_{—}}₂, has a substantially similar shape. The term for the embodiment of the present invention, D_{act}_{_{—}}₂, does however differ from the term in previous known solutions, D_{act}_{_{—}}₁, in being allowed to change in close proximity to the lowering of the desirable speed v_{des}, since the I term, I_{act}_{_{—}}₂, is set to the value zero.

The corresponding term for previous known solutions, D_{act}_{_{—}}₁, takes this step somewhat later in time when the P term, P_{act}_{_{—}}₁, takes out, i.e. compensates for, the I term I_{act}_{_{—}}₁. This means that the step in the target speed v_{des} is not reflected immediately in the actual speed in previous known solutions, v_{act}_{_{—}}₁, resulting in difficulties in predicting a lowest speed for the reference-speed-regulating cruise control, with possible reduction also of the fuel saving potential.

In one embodiment of the present invention, not only the speed regulator 120 but also the function of the turbo unit 131 in the engine system 130 is also guided when a change in the target speed v_{des} has been identified, if the I element's absolute amount has an undesirable configuration. In other words, the turbo function is guided if it is desirable that a simulated vehicle speed vₛᵢₘ in the reference-speed-regulating cruise control should correspond to the actual speed v_{act}.

In one embodiment, the function of the turbo unit 131 is affected by this form of control in that the turbo pressure decreases considerably. Here the turbo pressure is therefore dumped immediately when it is found that there is a change in the target speed v_{des}, if the I element's absolute amount has an undesirable configuration, resulting in reduced engine friction losses (since the air resistance during the compression decreases with decreasing exhaust backpressure) and in less fuel consumption for the vehicle.

In one embodiment of the present invention, not only the curtailment of the regulating algorithm's influence upon the speed regulation but also at least one power train resistance-changing measure also takes place when it has been found that there is a change in the target speed v_{des} and the I element's absolute amount has an undesirable configuration.

An example of a power train resistance-reducing measure is a change in the gear ratio of the gearbox 103 in the vehicle 100. The resistance in the power train may be reduced by engaging a neutral gear. The running resistance may also be reduced by engaging a higher gear, i.e. a gear which involves a lower engine speed and hence also less friction in the engine. This results in less running resistance because of the lower engine speed, which means that the vehicle acquires a slower/gentler change in the actual speed v_{act} in response to a change in the target speed v_{des}.

These reductions in the resistance in the power train reduce the vehicle's total fuel consumption and also the wear on the power train components. In particular, changing up to higher gears results in a lower speed for the engine system 130 and consequently smaller losses in the power train as a whole.

An example of a power train resistance-increasing measure is a change in the gear ratio of the gearbox 103 in the vehicle 100. The resistance in the power train may here be increased by a downward gear change, i.e. by engaging a gear which results in a higher engine speed, increased running resistance and also greater counterforce in engine braking. This makes use of the fact that the friction pertaining to the engine increases with increasing engine speed, i.e. the power train resistance increases with increasing speed of the engine.

It is important here to achieve in the context of a reference-speed-regulating cruise control, e.g. an LACC, a good match between a simulated vehicle speed vₛᵢₘ and an actual vehicle speed v_{act} at a lowering. In one embodiment, the parasitic losses and/or the resistance in the power train components may also be increased in order to achieve quicker speed lowering on heavy vehicles.

In one embodiment of the present invention, the curtailment of the regulating algorithm's influence, i.e. the manipulation or elimination of the memory term in the algorithm, the temporary departure from regulation according to the algorithm, and/or possibly the dumping of the turbo pressure and/or the change in the gear ratio of the gearbox 103, causes a relatively large decrease in the torque M taken out of the engine system 130. The magnitude of this decrease should with advantage be such as to be found comfortable for a driver and/or passengers in the vehicle 100. Good comfort and operating sensation for the vehicle are thus maintained even when a substantial fuel saving is made.

The decrease has in one embodiment to be as great as possible without being found uncomfortable, which mostly depends on the vehicle's train weight, since the train weight reduces the influence of propulsive torque and causes comfortable running.

In one embodiment of the present invention, information about road sections ahead is used to identify whether there is a change in the target speed v_{des} and whether the I element's absolute amount has an undesirable configuration. Such information about the road section ahead may comprise one or more from among topography, road curvature, traffic situation, roadworks, traffic density and road surface state.

Information from a cruise control and/or a speed regulator may also be used for this identification of a change in the target speed v_{des} and of an undesirable configuration of the I element's absolute amount, since accelerations and/or decelerations and/or torque requirements may thus be predicted. Driver input may also be used in the identification.

As mentioned above, knowledge of road sections ahead may be used in economical cruise controls, e.g. LACCs. It may for example comprise prevailing topography, road curvature, traffic situation, roadworks, traffic density and road surface state. It may also comprise a speed limit on the road section ahead, and a traffic sign beside the road. One embodiment of the present invention uses at least one of these kinds of knowledge in identifying the change in the target speed v_{des} and an undesirable configuration of the memory term, and to determine an influence of parasitic losses and resistances in the power train so that a simulated speed vₛᵢₘ and an actual speed v_{act} become as equal to one another as possible. This is highly advantageous and computationally efficient, since these kinds of knowledge are readily available on board the vehicle. They may therefore be used here for various purposes, both for cruise control and to identify the change in the target speed v_{des} and an undesirable configuration of the memory term. The control of at least the speed regulator 120 and possibly also the turbo unit 131 and/or the gearbox 103 according to the present invention may thus be implemented with very little in terms of extra calculations or complexity.

These kinds of knowledge may for example be obtained by means of location information, e.g. GPS (global positioning system) information, map information and/or topographical map information, weather reports, information communicated between vehicles and information communicated by radio.

For example, information about the topography of road sections ahead may be used to identify upgrades and/or downgrades on which regulating error may occur, e.g. because of dragging of the engine system 130. The change in the target speed v_{des} and an undesirable configuration of the memory term may thus also be identified.

If a reference-speed-regulating cruise control is used in the vehicle, a change in the actual speed v_{act} may be because the reference speed v_{ref}, which then corresponds to the target speed v_{des}, changes relative to the set speed vₛₑₜ. Regulating error e, due for example to dragging of the engine system 130, may occur in association with such speed changes, so information from the cruise control may be used in identifying the change in the target speed v_{des} and in identifying an undesirable configuration of the memory term.

In a similar way, information about curvature of road sections ahead may be used to identify coming speed changes and regulating error e, and hence to identify the change in the target speed v_{des} and to identify an undesirable configuration of the memory term, since the regulating error e arises from the fact that the actual speed v_{act} often drops at bends, particularly at sharp bends, before increasing again after them.

Similarly, information about traffic situations on road sections ahead may be used to identify coming changes in the target speed v_{des} and to identify undesirable configurations of the memory term. Here knowledge about, for example, a red light ahead may conceivably be used to identify at least one likely change in speed close to the red light, resulting in regulating error e.

Knowledge of roadworks ahead may also be used to identify coming changes in the target speed v_{des} and to identify undesirable configurations of the memory term, since speed limits and hence regulating error e usually occur close to roadworks.

Information about traffic density on road sections ahead may also be used to identify coming changes in the target speed v_{des} and to identify undesirable configurations of the memory term, since traffic queues will for example make it necessary to reduce speed, whereupon regulating error e occurs.

Road surface state also affects vehicle speed, since a lower speed needs to be maintained where the surface state is bad, e.g. when there is ice, than where it is good. Information about the surface state of road sections ahead may thus also be used to identify coming changes in the target speed v_{des} and to identify undesirable configurations of the memory term.

Driver input may also be used to identify coming changes in the target speed v_{des} and to identify undesirable configurations of the memory term. Here the user interface may for example be equipped with at least one input device which the driver can use. If the driver sees that a change in the target speed v_{des} and an undesirable configuration of the memory term are likely to occur shortly, he/she may here make some kind of input which the system interprets to the effect that such a situation will arise. As a non-limitative example, the driver may make such an input if he/she sees a stationary queue, an accident or an area of bad surface on the road ahead, or a long downgrade coming. Here such input may be interpreted to the effect that a change in the target speed v_{des} and an undesirable configuration of the memory term will occur after a first amount of time has elapsed since the input.

As mentioned above, in reference-speed-regulating cruise controls, e.g. LACCs, the reference speed v_{ref} is allowed to differ from the set speed vₛₑₜ. In one embodiment of the present invention, a change in the target speed v_{des} and an undesirable configuration of the memory term are regarded as identified if the magnitude of the reference speed v_{ref} changes. This is illustrated schematically in FIGS. 3 and 4.

Here the knowledge that speed changes which follow changes in the reference speed v_{ref} are based on the memory term is used, since the regulating error is integrated upwards during the time when the speed change takes place. Immediately then identifying a change in the target speed v_{des} and an undesirable configuration of the memory term on the basis of this knowledge results in a very quick and effective curtailment of the influence of the regulating algorithm, e.g. elimination of the memory term in the algorithm.

In one embodiment of the invention the elimination takes place each time the magnitude of the reference speed v_{ref} changes.

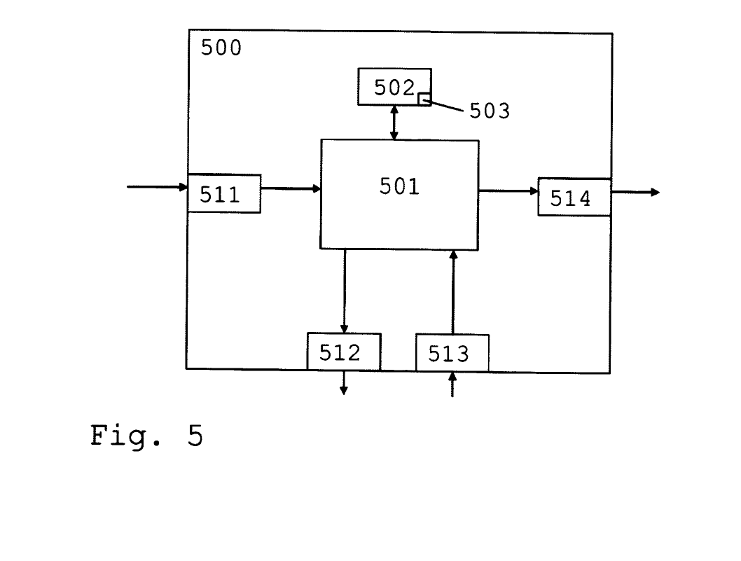

One skilled in the art will appreciate that the method for control of at least one speed regulator according to the present invention may also be implemented in a computer programme which, when executed in a computer, causes the computer to conduct the method. The programme usually takes the form of a computer programme product 503 (depicted in FIG. 5) stored on a digital storage medium and is contained in a computer-readable medium of the computer programme product. Said computer-readable medium comprises a suitable memory, e.g. ROM (read-only memory), PROM (programmable read-only memory), EPROM (erasable PROM), flash memory, EEPROM (electrically erasable PROM), a hard disc unit, etc.

FIG. 5 depicts schematically a control unit 500 adapted to being able to control at least one speed regulator 120. The control unit 500 comprises a calculation unit 501 which may take the form of substantially any suitable kind of processor or microcomputer, e.g. a circuit for digital signal processing (digital signal processor, DSP), or a circuit with a predetermined specific function (application specific integrated circuit, ASIC). The calculation unit 501 is connected to a memory unit 502 which is situated in the control unit 500 and which provides the calculation unit with, for example, the stored programme code and/or the stored data which the calculation unit needs to enable it to perform calculations. The calculation unit is also adapted to storing partial or final results of calculations in the memory unit 502.

The control unit 500 is further provided with respective devices 511, 512, 513, 514 for receiving and sending input and output signals. These input and output signals may comprise waveforms, pulses or other attributes which the input signal receiving devices 511, 513 can detect as information and which can be converted to signals which the calculation unit 501 can process. These signals are then conveyed to the calculation unit. The output signal sending devices 512, 514 are arranged to convert signals received from the calculation unit in order, e.g. by modulating them, to create output signals which can be conveyed to other parts of systems on board the vehicle, e.g. to the speed regulator 120, the engine system 130, the turbo unit 131 or the gearbox 103.

Each of the connections to the respective devices for receiving and sending input and output signals may take the form of one or more from among a cable, a data bus, e.g. a CAN (controller area network) bus, a MOST (media oriented systems transport) bus or some other bus configuration, or a wireless connection.

One skilled in the art will appreciate that the aforesaid computer may take the form of the calculation unit 501 and that the aforesaid memory may take the form of the memory unit 502.

One aspect of the present invention proposes a system for control of at least the speed regulator and in certain embodiments for control also of a turbo unit 131 and/or a gearbox 103. The system according to the invention comprises an identification unit adapted to identifying a change in the target speed v_{des}. The system comprises also a determination unit adapted to determining an absolute amount for the memory term in the regulating algorithm. The system comprises also a curtailment unit adapted to curtailing the algorithm's influence upon the engine system if the memory term's absolute amount has an undesirable configuration. In one embodiment of the invention this curtailment may take the form of eliminating the memory term in the algorithm.

One skilled in the art will also appreciate that the above system may be modified according to the various embodiments of the method according to the invention. The invention relates also to a motor vehicle, e.g. a truck or a bus, which is provided with the system for controlling at least the speed regulator according to the invention.

The present invention is not restricted to the invention's embodiments described above but relates to and comprises all embodiments within the protective scope of the attached independent claims.

1. A method for control of at least one speed regulator (120), which regulator (120) regulates an engine system (130) in a vehicle (100) on the basis of a regulating algorithm, so that an actual speed v_{act} of said vehicle (100) is guided towards a target speed v_{des},
characterised by
identifying a change in said target speed v_{des},
determining an absolute amount for a memory term of said algorithm, which memory term is related to a history of the regulation of said engine system (130) by said speed regulator (120), and
curtailing the influence of said algorithm upon said engine system (130) if it is determined that said absolute amount of said memory term has an undesirable configuration.

2. A method according to claim 1, in which said absolute amount of said memory term has an undesirable configuration if said absolute amount decreases after said identified change in said target speed v_{des}.

3. A method according to either of claims 1 and 2, in which said step of curtailing the influence of said regulating algorithm upon said engine system (130) comprises temporarily departing from regulation according to said algorithm.

4. A method according to claim 3, in which said departure from said regulation according to said regulating algorithm comprises a limitation of a demanded engine torque initially after said change, followed by resumption of said regulation based on said algorithm.

5. A method according to either of claims 1 and 2, in which said step of curtailing the influence of said regulating algorithm upon said engine system (130) comprises manipulating said memory term.

6. A method according to claim 5, in which said manipulation comprises said memory term being given initially after said change a value such that said memory term compensates for a proportional term and/or a derivative term in said regulating algorithm.

7. A method according to claim 5, in which the manipulation of said memory term comprises its elimination.

8. A method according to any one of claims 1-7, in which said regulating algorithm is a PID algorithm and said memory term takes the form of an integrating term I in said PID algorithm.

9. A method according to claim 8, in which said integrating term I is given the value zero (0) at an elimination.

10. A method according to any one of claims 1-9, in which said control further comprises acting upon a function of a turbo unit (131) in said engine system (130) when it is determined that said absolute amount of said memory term has said undesirable configuration.

11. A method according to claim 10, in which said action upon said function results in a considerable decrease in a turbo pressure of said turbo unit (131).

12. A method according to any one of claims 1-11, in which said control further comprises effecting at least one measure which changes a resistance of a power train in said vehicle (100) when it is determined that said absolute amount of said memory term has an undesirable configuration.

13. A method according to claim 12, in which said at least one measure comprises a change of gear ratio in a gearbox (103) in said vehicle (100).

14. A method according to claim 13, in which said change of said gear ratio comprises one of the following:
engaging a neutral gear,
engaging, when said change takes the form of a lowering of said resistance of said power train, a lower-speed gear than the vehicle speed would have required, resulting in a relatively slow decrease in the deviation of said actual speed v_{act}, from said target speed v_{des},
engaging, when said change takes the form of a raising of said resistance of said power train, a higher-speed gear than the vehicle speed would have required, resulting in an increased running resistance.

15. A method according to any one of claims 1-14, in which said control in aggregate reduces a torque from said engine system (130) as much as possible without the decrease being found uncomfortable for a driver of said vehicle (100).

16. A method according to any one of claims 1-15, in which said engine system (130) will be dragged during the curtailment of said regulating algorithm's influence upon said engine system (130), a fuel supply to said engine system (130) being throttled when said engine system is dragged, and said engine system (130) contributing substantially no propulsive force.

17. A method according to any one of claims 1-16, in which said identification is based on at least one of the following forms of information:
cruise control information,
regulator information,
topography information,
road curvature information,
traffic situation information,
roadworks information,
traffic density information,
road surface state information, and
driver input.

18. A method according to claim 17, in which said at least one form of information is provided by at least one of the following devices:
cruise control,
speed regulator,
positioning device,
map information device,
image recording device,
input device,
traffic information device, and
road surface state information device.

19. A method according to any one of claims 1-18, which determines that said absolute amount of said memory term has an undesirable configuration if there is a change in said target speed v_{des}.

20. A method according to claim 19, in which elimination of said memory term takes place each time there is a change in a magnitude of said target speed v_{des}.

21. A computer programme which comprises programme code and which when said programme code is executed in a computer causes said computer to conduct the method according to any one of claims 1-20.

22. A computer programme product comprising a computer-readable medium and a computer programme according to claim 21, which programme is contained in said medium.

23. A system for control of at least one speed regulator (120), which regulator (120) is adapted to regulating an engine system (130) in a vehicle (100) on the basis of a regulating algorithm, so that an actual speed v_{act} of said vehicle (100) is guided towards a target speed v_{des},
characterised by
an identification unit adapted to identifying a change in said target speed v_{des},
a determination unit adapted to determining an absolute amount for a memory term of said algorithm, which memory term is related to a history of the regulation of said engine system (130) by said speed regulator (120), and
a curtailment unit adapted to curtailing the influence of said algorithm upon said engine system (130) if it is determined that said absolute amount of said memory term has an undesirable configuration.
